(19) United States
(12) Patent Application Publication
(10) Pub. No.: US 2006/0206292 A1
(43) Pub. Date: Sep. 14, 2006

(54) Method and apparatus to utilize the probability vectors in the binary representation of video systems for faster convergence with minimal computation requirements

(76) Inventor: Walid Ali, Montrose, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/545,840

(22) PCT Filed: Nov. 25, 2003
(86) PCT No.: PCT/IB03/05422

§ 371 Date: Aug. 17, 2005

Related U.S. Application Data
(60) Provisional application No. 60/431,221, filed on Dec. 5, 2002.

(51) Int. Cl. G06F 17/10

(52) U.S. Cl. 703/2

(57) ABSTRACT

A system for utilizing probability vectors in a binary representation, so as to permit optimization of video much faster than by using genetic algorithm. The system includes a binary representation module (107) that converts a video chain into a binary representation having a predetermined number of bits, a cascaded four-module video processing chain for processing the binary represented video chain, which has: (1) a spatial poly-phase scalar module (101); (2) a noise reducer module (102); (3) a sharpness enhancer module (103); (4) a histogram module (104); wherein an initial cascading order of the four-module video processing chain is random. An optimization algorithm module optimizes an order of cascading of from a random cascading to an optimized order based on video quality. The optimizing can operate so long as there are video chains present, making the apparatus self-correcting as it improves over time.

The present invention relates to video systems, such as television sets that interact and use a number of algorithms to improve video quality. More importantly, the present invention relates to an apparatus and method to utilize probability patterns to maximize the probability of best solutions.

In order to enhance the quality of existing video chains, new algorithms are sometimes introduced to process the chains. Conversely, sometimes new video chains are introduced. The present inventor has previously taught that video chains can be represented by binary representation while deploying genetic algorithms (GA) for finding the best global solution, so that the settings of the video chains result in the best picture quality, and incorporates herein by reference as background material U.S. patent applications: Ser. No. 09/817,981 entitled “System and Method for Optimizing Control Parameter Settings in a Chain of Video Processing Algorithms”, filed Mar. 27, 2001; serial no, 09/734,823 entitled “System and Method for Providing A Scalable Dynamic Objective Metric For Automatic Video Quality Evaluation” filed Dec. 12, 2000.

However, as genetic algorithms are iterative procedures that maintain a population of candidate solutions in the form of chromosomes, there will be some degree of difficulty in their use in smart consumer products, which need to carry out optimization “on the fly.” Such “on the fly” optimization patterns will rapidly gear a solution toward the global optima, while keeping the computation need at a minimum level.

The present invention is directed to a method and apparatus that utilizes PROBABILITY vectors to extract probability patterns in a video device so that the device will maximize the probability of good solutions and minimizing the probability of bad solutions. The aforementioned is performed while keeping the computational needs at a minimum.

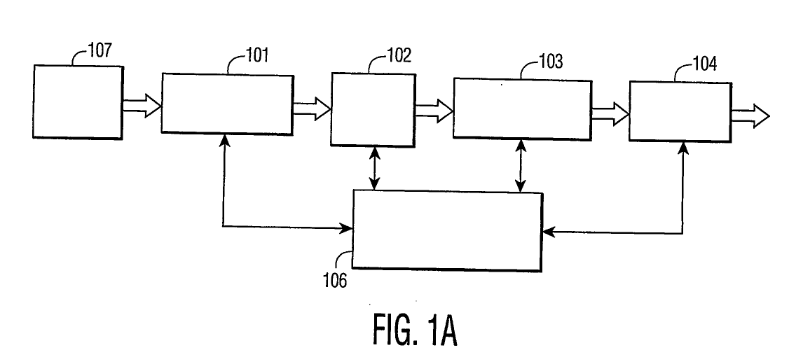

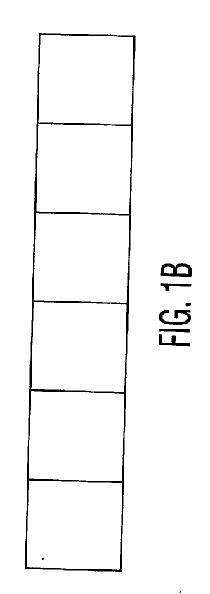

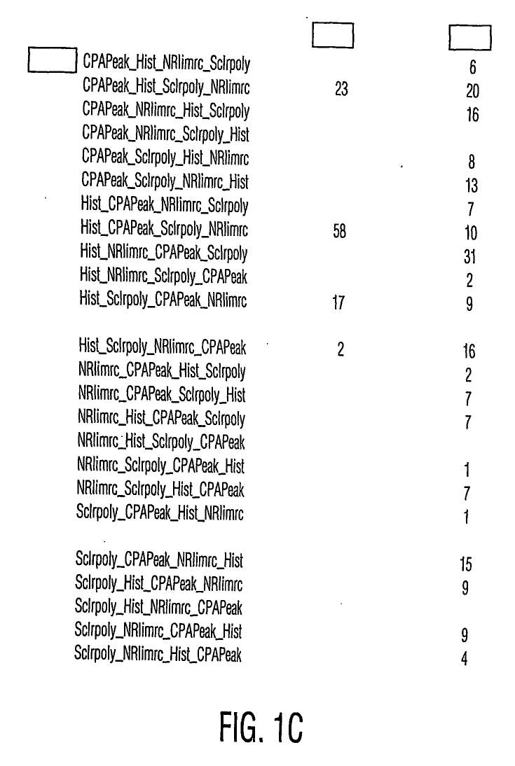

FIG. 1A illustrates a four module video chain represented by 19 bit-binary chromosomes

FIG. 1B includes a distribution of gene 1 in best and worst solution regions.

FIG. 1C is an overview of how such an optimization process occurs according to the present invention.

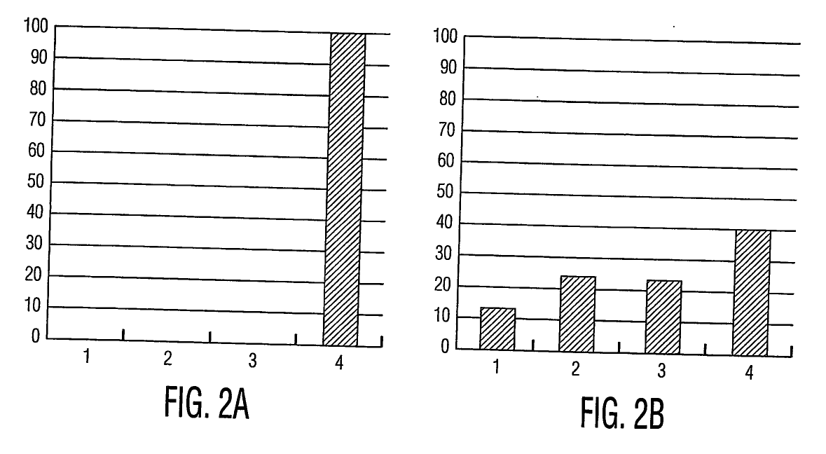

FIGS. 2A and 2B illustrate probability distribution of Gene 2 in the best and worst solution regions, respectively.

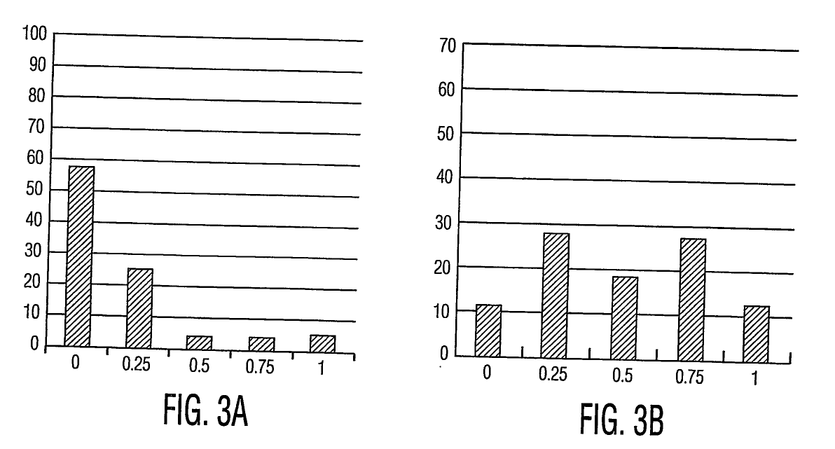

FIGS. 3A and 3B illustrate probability distribution of Gene 3 in the best and worst solution regions, respectively.

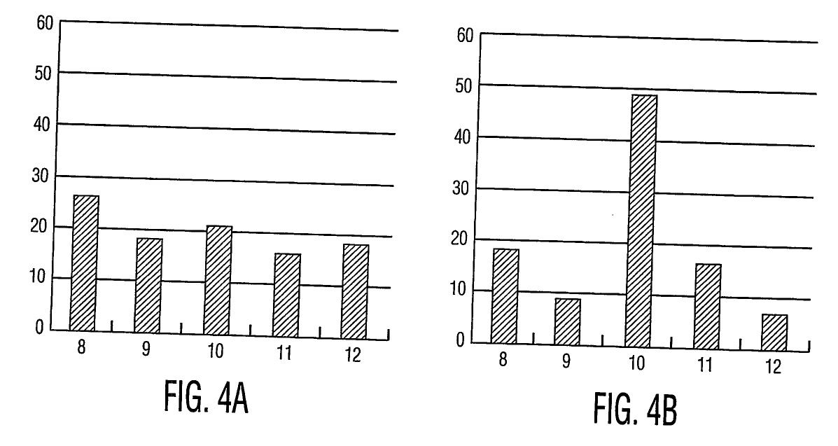

FIGS. 4A and 4B illustrate probability distribution of Gene 4 in the best and worst solution regions, respectively.

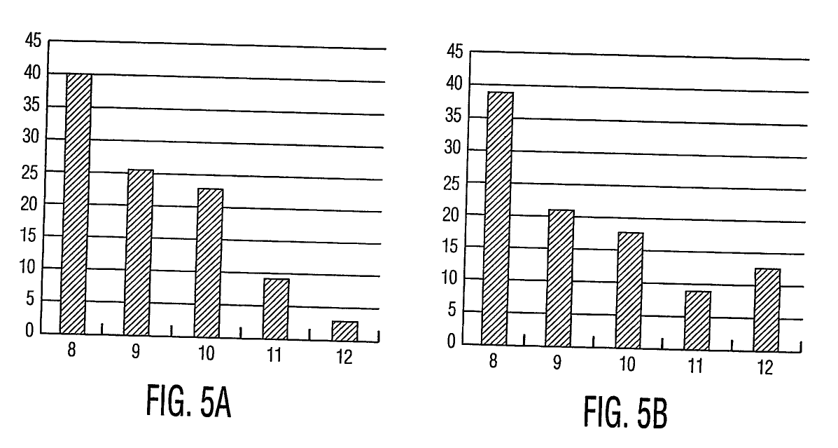

FIGS. 5A and 5B illustrate probability distribution of Gene 5 in the best and worst solution regions, respectively.

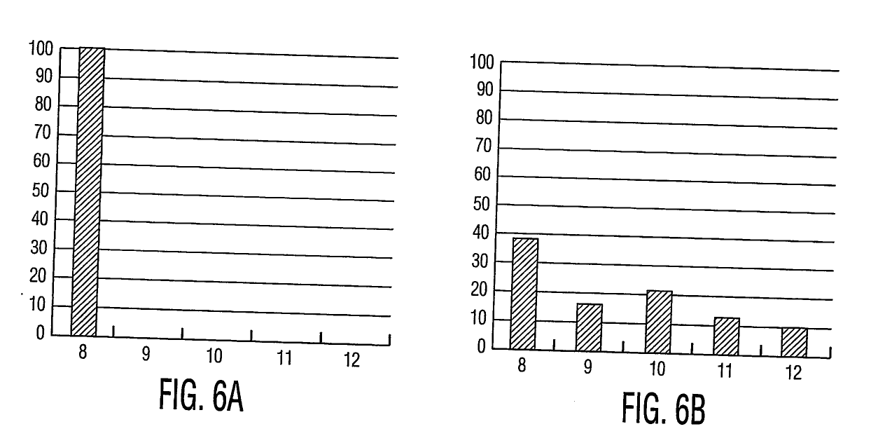

FIGS. 6A and 6B illustrate probability distribution of Gene 6 in the best and worst solution regions, respectively.

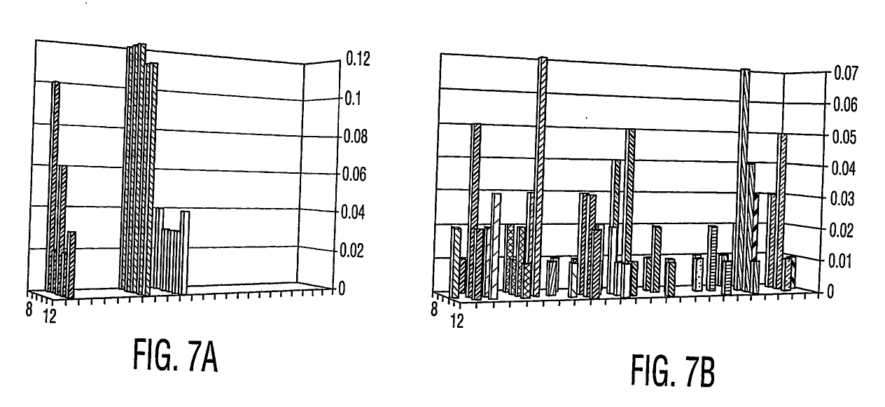

FIGS. 7A and 7B illustrate a joint probability distribution between Genes 1 and 4.

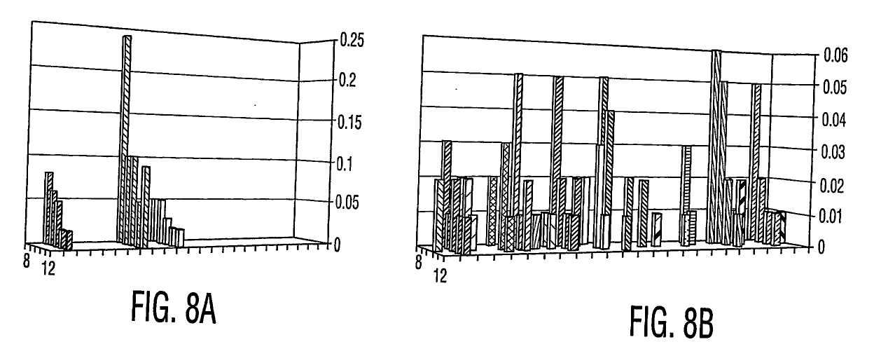

FIGS. 8A and 8B illustrate a joint probability distribution between Genes 1 and 5.

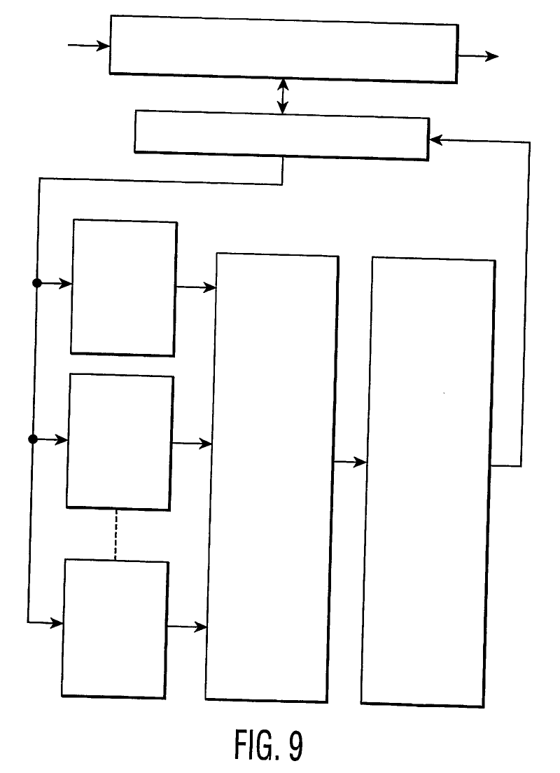

FIG. 9 illustrates one example of an apparatus for self-improving video devices.

In order to illustrate one way that a person of ordinary skill can practice the invention, there is a presentation of the analysis needed to build the probability patterns, which were obtained from a simple video chain. Subsequently, the apparatus extracts probability patterns (aka vectors) and how to use it to gear the video device toward self-improvement by maximizing the probability of good solutions and by minimizing the probability of bad ones. This process is performed with keeping the computational needs at a minimum.

FIG. 1A shows one way for an apparatus to extract probability vectors and control the video chain according to the present invention. It should be understood by persons of ordinary skill in the art that the there are many possible combinations that could have equivalent functions, and the purpose of the present example is for illustrative purposes, and not to be construed as a means for limitation.

According to FIG. 1A, the system includes four video modules, namely a spatial poly-phase scalar module 101, a noise reducer module 102, a sharpness enhancer module 103 by luminance peaking and a histogram modification module 104. The four modules are cascaded, but it is not an absolute requirement to cascade them in a specific order.

With regard to sharpness enhancement, which is nowadays a fairly common feature in TV sets, there is a focus on improving the perceived sharpness of the luminance signal. By boosting the higher frequencies in the luminance signal one basically enhances the sharpness. However, this process can lead to aliasing artifacts that obviously need to be prevented. A different set of sub-algorithms, contrast control, clipping prevention, dynamic range control and adaptive coring, all of which compete to reduce the aliasing artifacts. Each of them provides a gain factor that can safely boost the higher frequencies. A selector sub-unit decides which one of these competing gain factors will be used.

With regard to the noise reduction module, this feature typically reduces higher frequency components based on measuring the presence of noise.

With regard to the poly-phase scalar module, they are normally implemented using FIR filters. The horizontal scalers process each line of input video data and generate a horizontally scaled line of output video data. In the case of expansion, this process is done by up-sampling that is performed either by a polyphase filter for which the horizontal expansion factor determines the filter phases required to generate each output pixel, or by a filter that uses this factor to interpolate the output pixels from the input pixels. In the case of compression, a transposed polyphase filter is used to down-sample the input data, and the horizontal compression factor determines the required filter phases. The vertical scalers, in contrast, generate a different number of output video lines than were input to the module, with input and output lines having the same number of pixels. In the case of expansion, at least one line of video data is output for each line that is input to a polyphase filter, for which the vertical expansion factor determines the number of up-sampled lines generated in response to an input line, along with the required filter phases, or by a polyphase filter that uses this factor to interpolate the output lines from the input line. In the case of compression, at most one line of video data is output for each line that is input to a transposed or non-transposed polyphase filter for which the vertical compression factor determines whether a down-sampled line is generated in response to an input line, along with the required filter phases.

The histogram modification stretches out the luminance vales for the black color and the white color to better represent the color contents of the video sequence.

An optimization algorithm module 106 operates with each of the above four modules 101,102,103 and 104 as generically as possible. The algorithm assumes no prior information about any of the particular of modules, or connectivity constraints (such as the cascaded modules' order). Both the data precision (e.g. number of bits in a data bus, i.e. bus width) between two cascaded modules as well as the cascaded modules order are considered parameters to optimize. The probability pattern of each gene and pair of genes occurs by optimizing the parameters, so as to provide a gene value selection that maximizes the probability of the best solution and minimizes the probability of the worst solution. The entire process can be done in real time (“on the fly”) with minimal computational power.

FIG. 1B shows a binary string to represent the video chain 105 under study. Each set of bits, which represent a certain parameter in the optimization process is called a “gene”. In this case, 19 binary bits are represented by six genes 110, 115, 120, 125, 130, 135.

FIG. 1C provides a table reporting on the analysis of each gene in the 100 best and 100 worst found solutions. This analysis is done for each gene before drawing the joint probability pattern. Gene 1 is limited to only 3 out of 24 values in best solutions, as it can be seen from the table that the solutions in the “good” column only outnumber the solutions in the “bad” column when the good is 23, 58, and 17. The probability for each is 58%, 23%, 17% and 2% as shown in FIG. 1B.

FIG. 2 shows probability distribution for Gene 2, with FIG. 2A representing the best solution region, and FIG. 2B representing the worst solution regions. Gene 2 is always set as the same value (NR=4) in the best and uniformly distributed in the worst solution region.

FIGS. 3A and 3B represent the third gene. This probability distribution appears biased towards lower values at best, and mid-range values at the worst solution region.

FIGS. 4A and 4B represent the fourth gene. As shown in the drawings, the probability distribution appears to be uniformly distributed in both subsets of solution regions.

FIGS. 5A and 5B also show a rather uniform distribution with a biasing toward the NR=8 value for gene five.

FIGS. 6A and 6B also show a biasing toward the NR=8 value, where gene six is set to NR=8 at the best regions.

There is a trend in the available data for genes 1,2 and 6. This trend can be further extracted from the device while running. Moreover, for genes which lack decisiveness (e.g. genes 4 and 5), its joint probability distribution with another well behaving gene (E.G. gene 1) can be used better to set its values.

FIGS. 7A and 7B show the joint probability distribution of Gene 1 and Gene 4 in good p(Gene1, Gene4|Good) and P(Gene1, Gene4|bad).

Similarly, FIGS. 8A and 8B show the joint probability distribution between genes 1 and 5. Thus, the result is that probability patterns, built as previously described will gear toward gene values that maximize the probability of best solutions and minimizes the probability of bad solutions. The video chain will be analyzed again and again and the statistical results are extracted to continuously build probability distribution of each of the genes, and gene value selection to maximize the probability of the best solution, and minimize the probably of the worst solution, which are then fed back so that parameter settings are optimized.

FIG. 9 shows that video chain 905 is input into the apparatus 900 and output as an optimized chain. First a binary string representation module 910 is used to represent the video chain, in the present case by 19 bits. Of course, this number can be more or less than 19. At 915a, 915b, 915n . . . the number of occurrences of each permitted value in a respective gene is stored. At 920, there is the probability distribution taken of each gene and each pair of genes in both best and worst regions. This data is fed to the gene value selection module 925 that selects genes according to the probability distribution provided by module 920 to maximize the probability of good solutions and minimize the probability of bad solutions. This data is in turn fed back to the binary string representation module 910, which builds probability vectors (patterns) and to the video chain so that there are ongoing adjustments to the video chain/chains. This apparatus is actually a self-improving video device.

It should be understood that there are various modification that a person of ordinary skill in the art could make that do not depart from the spirit of the invention or the scope of the appended claims. For example, the number of bits can be significantly more or less than 19, and the number of genes can be higher or lower than six. The number of modules can be more than four or less than four, depending on the degree of accuracy one wishes to obtain during the optimization procedure.

1. A system for utilizing probability vectors in a binary representation, comprising:
a binary representation module 107 that uses probability vectors to convert a video chain into a binary representation comprising a predetermined number of bits;
a cascaded four-module video processing chain 101,102,103,104 for processing the binary represented video chain, said four module processing chain comprising:
(1) a spatial poly-phase scalar module 101;
(2) a noise reducer module 102;
(3) a sharpness enhancer module 103;
(4) a histogram module 104;
wherein an initial cascading order of the four-module video processing chain is random; and
an optimization algorithm module 106 that optimizes an order of cascading of from a random cascading to an optimized order based on video quality.

2. The system according to claim 1, wherein the optimization algorithm module optimizes settings of the four module video processing chain by determining a bus width between any two of the cascaded modules.

3. The system according to claim 1, wherein the binary representation module 107 represents the video chain as a binary string 105 comprising at least a 19 binary bit chromosomes distributed among more than five genes.

4. A system for utilizing probability vectors in a binary representation, comprising:
a binary representation module 107 that uses probability vectors to convert a video chain into a binary representation comprising a video chain having a predetermined number of bits;
a cascaded four-module video processing chain 101,102,103,104 for processing the video chain, said processing chain comprising:
(1) a spatial poly-phase scalar module 101 having an output;
(2) a noise reducer module 102 cascaded to the output of said spatial poly-phase module;
(3) a sharpness enhancer module 103 cascaded to an output of the noise reducer module;
(4) a histogram module 104 cascaded to an output of the sharpness enhancer module; and
an optimization algorithm module 106 that optimizes settings of the four module video processing chain including a bus width between any two of the cascaded modules.

5. The system according to claim 4, wherein the optimization algorithm module optimizes settings of the four module video processing chain by determining a bus width between any two of the cascaded modules.

6. The system according to claim 5, wherein the binary representation module 107 represents the video chain as a binary string 105 comprising 19 binary bit chromosomes distributed among six genes.

7. The system according to claim 4, wherein the module video processing chain comprises more than four video modules.

8. A self-improving video apparatus, comprising:
means for receiving a video chain 905;
a binary representation module 910 for representing the video chain 905 in a predetermined number of bits grouped into a predetermined number of genes 1 to n based on probability vectors;
extraction and storage means 915a, 915b, 915n for extracting a number of occurrences of each permitted value for each of genes 1 to n in solutions having possible good and bad solutions;
probability distribution means 920 for performing probability distribution of each of genes 1 to n retrieved from extraction and storage means 915a,915b, 915n by building probability vectors for each possible pair of genes from among genes 1 to n for providing probability distribution in both a number of best regions having a highest probability and a number of worst regions having a lowest probability distribution; and a
gene value selection means 925 in communication with the probability distribution means for maximizing the probability of a best solution and minimizing the probability of a worst solution, wherein said gene value selection means 925 provides feedback to said binary string representation module 910, and wherein said binary string representation module 910 selects another set of genes to update the quality of the video chain.

9. The apparatus according to claim 8, wherein the binary representation module represents the video chain in at least 19 bits among a predetermined number of genes.

10. The apparatus according to claim 9, where the probability distribution means 920 includes an algorithm module for optimizing parameter settings, and wherein the predetermined number of bits are grouped into a predetermined number of genes.

11. A method of utilizing probability vectors in the binary representation of video systems, comprising the steps of:
(a) extracting a number of occurrences of each gene in a binary representation of a video chain together with its presence in good/bad solution regions;
(b) building probability vectors for each gene/pair of genes in both good and bad solution regions;
(c) setting gene values based on the probability in step (b); and
(d) maximizing the probability of having a solution in the best region and minimizing the probability of having a solution in the bad solution region.

12. The method according to claim 11, wherein step (a) includes a first sub-step of (i) converting a video chain into a binary representation having a predetermined number of bits and a predetermined groupings of bits into genes.

13. The method according to claim 11, wherein steps (b), (c) and (d) are performed by an optimizing algorithm.

14. The method according to claim 13, the binary representation of the video processing chain is subsequently processed by a cascaded four module video processing chain.

15. The method according to claim 14, wherein the cascading of the four video modules is initially random, and the optimizing algorithm finds an order of cascading that optimizes a probability result.

16. The method according to claim 11, wherein step (b) includes using probability distribution of a best and worst of each individual gene.

17. The method according to claim 11, wherein step (b) includes using joint probability distribution for each of the different pairs of genes.

18. The method according to claim 14, wherein the optimization algorithm includes optimizing a bus width of the cascading between the four video modules.

19. The method according to claim 14, wherein the cascaded four video modules includes a spatial poly-phase scalar module 101, a noise reducer module 102, a sharpness enhancer module 103, and a histogram module 104.

20. The method according to claim 11, wherein steps (a) through (d) are repeated for a duration of a video chains or chains.
